(19) United States
(12) Patent Application Publication
(10) Pub. No.: US 2022/0092710 A1
(43) Pub. Date: Mar. 24, 2022

(54) Real Estate Mortgage Analysis Browser Extension

(71) Applicant: StackSource, Inc., New York, NY (US)

(72) Inventors: Timothy Robert Milazzo, New Smyrna Beach, FL (US); Brandon Robert Lipman, Mason, OH (US)

(21) Appl. No.: 17/479,773

(22) Filed: Sep. 20, 2021

Related U.S. Application Data
(60) Provisional application No. 63/080,487, filed on Sep. 18, 2020.

(51) Int. Cl. G06Q 50/16; G06Q 40/06; G06Q 40/02; G06F 16/955; G06F 16/957

(52) U.S. Cl. CPC G06Q 50/16; G06Q 40/06; G06F 16/957; G06F 16/955; G06Q 40/025

(57) ABSTRACT

A unique method provides real estate mortgage and investment analyses to a user. The method is implemented through a mortgage analyzer that comprises an add-on extension to an Internet browsing client. The method facilitates analyses for prospective real estate properties with various input data and allows easy sharing of analysis results with others. The method offers mortgage scenario comparison and investment option analysis that provide not only the optimal mortgage choice, but also the most promising investment opportunity. Additionally, the method scrapes information directly off property listing webpages viewed by the user, eliminating the need for manual input of information the user is already viewing. Further, the method allows the user to initiate a mortgage loan application directly to a desired mortgage lender entity. Thus, the present invention provides a versatile and powerful method to the user to make optimal decisions for real estate mortgage borrowing and investment opportunities.

The current application claims a priority to the U.S. Provisional Patent application Ser. No. 63/080,487 filed on Sep.18, 2020. The current application is filed on Sep. 20, 2021 while Sep. 18 and 19, 2021 were on a weekend.

### FIELD OF THE INVENTION

The present invention relates generally to mortgage lending. More particularly, the present invention relates to a mortgage and investment analysis method for online real estate property listings through a website browser extension app that provides not only mortgage loan interest rates but also investment option comparisons for a prospective real estate property.

### BACKGROUND OF THE INVENTION

A mortgage loan, or mortgage, is a loan used either by purchasers of real property to raise funds to buy real estate, or alternatively by existing property owners to raise funds for any purpose while putting a lien on the property being mortgaged. The loan is “secured” on the borrower's property through a process known as mortgage origination, whereby a legal mechanism is put into place which allows the lender to take possession and sell the secured property, through foreclosure or repossession, to pay off the loan in the event the borrower defaults on the loan or otherwise fails to abide by its terms.

Mortgage borrowers may be individuals mortgaging their home or businesses mortgaging commercial property—for example, their own business premises, residential property let to tenants, or an investment portfolio. The lender will typically be a financial institution, such as a bank, credit union or building society, depending on the country concerned, and the loan arrangements can be made either directly or indirectly through intermediaries. Features of mortgage loans such as the size of the loan, maturity of the loan, interest rate, method of paying off the loan, and other characteristics can vary considerably.

A commercial mortgage is a financial product that is secured by using a commercial property as collateral, such as an office building, shopping center, industrial warehouse, or apartment complex. A commercial property is one that is used for the purpose of business, or as an investment. The proceeds from a commercial mortgage are typically used to acquire, refinance, or redevelop commercial property.

Commercial mortgages are a different financial product than what is typically referred to as a “mortgage”, which is a consumer loan used to purchase a residence. Commercial mortgages involve more structure than residential mortgages, and the borrower is an investor, or a business as opposed to a consumer.

Key terms in the structure of commercial mortgages include the loan amount (or “loan proceeds”), interest rate, term (or “maturity”), amortization schedule, and prepayment flexibility. Commercial mortgages are generally subject to extensive underwriting and due diligence prior to closing. The lender's underwriting process may include a financial review of the property and the property owner (or “sponsor”), as well as commissioning and review of various third-party reports, such as an appraisal.

Since the advent of the Internet, many areas of business have expanded to include an online presence to various extents. As the fundamental purpose of the Internet is to transfer information, industries dealing primarily or in large part with information are particularly well suited to online operations. Commercial mortgage lending is one such field.

Currently, there exist many prominent real estate websites and software platforms. Types of such online entities include property listing portals, mortgage calculators, commercial mortgage rate tables, and browser extensions. Property listing portals display information about specific properties to online users. Examples of current property commercial property listing portals include Loopnet and CREXi. A mortgage calculator takes user inputs, including a mortgage amount, an interest rate, and a loan term, and calculates the monthly payments and other relevant metrics for a user. A commercial mortgage calculator would do the same for a commercial mortgage. Commercial mortgage rate tables list various types of commercial mortgage lenders and state a range that a borrower can expect those lenders to charge on a commercial mortgage loan. Browser extensions add features to an individual's online experience, rather than existing websites. Several real estate browser extensions exist but are far from relevant to the present invention. Typically, unlike residential property listing sites, commercial property listing sites do not have mortgage calculators built in because commercial mortgages have additional complexity to solve for in discerning what a prospective commercial mortgage's rate and terms might be.

It is therefore the object of the present invention to provide a browser extension that enables a user viewing prospective real estate investment in their web browser to perform calculations about the prospective real estate investments, save the calculations in conjunction with the web page presenting the prospective real estate investment, and share the calculations with other users without leaving the browser window.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### SUMMARY OF THE INVENTION

The present invention offers a unique method for real estate mortgage and investment analysis. The innovative method is implemented through a mortgage analyzer to a user. The mortgage analyzer of the method comprises an add-on app, or extension, to an Internet browsing client. The method of the present invention effectively and efficiently facilitates mortgage calculations, mortgage scenario analyses, investment analysis, investment option comparisons, and mortgage rate table, etc.

The mortgage analyzer of the method enables the user to perform calculations and analyses about prospective real estate investments viewed on a webpage in an online web browser client, save the calculations/analyses in conjunction with the webpage, and share the results with other users without leaving the browser window. The method goes beyond basic calculations of mortgage loan payments based on various input data which combine the user's input with loan rates and parameters retrieved from various internal and external databases of relevant financial data such as current mortgage rates. The mortgage analyzer offers mortgage scenario comparison and investment option analysis that provides not only the optimal mortgage choice to the user, but also the most promising investment opportunity. Additionally, the mortgage analyzer of the present invention scrapes information directly off property listing webpages viewed by the user, eliminating the need for manual input of information the user is already viewing as part of the mortgage and investment return calculations and analyses.

The method employs an easy-to-use user interface that can be activated by user's desire or automatic detection of an open real estate listing website. Further, the method allows the user to initiate a mortgage loan application directly to a desired mortgage lender entity and guides the user through a series of decisions and steps based on the preferred mortgage type. Thus, the present invention provides a versatile and powerful method and app to the user to make optimal decisions for real estate mortgage borrowing and investment opportunities.

### BRIEF DESCRIPTION OF THE DRAWINGS

FIG. 1 is a block diagram illustrating the system overview of the present invention.

FIG. 2 is a flowchart for the overall process followed by the method of the present invention.

FIG. 3 is a flowchart for a sub-process for activating a mortgage analyzer app of the present invention.

FIG. 4 is a flowchart for a sub-process for acquiring input data for the mortgage analyzer of the present invention.

FIG. 5 is a flowchart for an alternative embodiment of the sub-process for acquiring input data for the mortgage analyzer of the present invention, wherein input data are retrieved from internal and/or external databases that contain real estate lending data.

FIG. 6 is a flowchart for another embodiment of the sub-process for acquiring input data for the mortgage analyzer of the present invention, wherein input data are retrieved from internal and/or external databases that contain real estate market data/information.

FIG. 7 is a flowchart for another embodiment of the sub-process for acquiring input data for the mortgage analyzer of the present invention, wherein input data are acquired through interactions with a specific user.

FIG. 8 is a flowchart for a sub-process for conducting analysis of the method of the present invention.

FIG. 9 is a flowchart for an alternative embodiment of the sub-process for conducting analysis of the method of the present invention, wherein a plurality of mortgage scenarios is analyzed.

FIG. 10 is a flowchart for another embodiment of the sub-process for conducting analysis of the method of the present invention of the present invention, wherein a decision tree is determined for the specific user based on desired type of mortgage loan.

FIG. 11 is a flowchart for another embodiment of the sub-process for conducting analysis of the method of the present invention, wherein an optimal mortgage lender is determined for the specific user.

FIG. 12 is a flowchart for another embodiment of the sub-process for conducting analysis of the method of the present invention, wherein a plurality of investment metrics for a specific real estate property is determined.

FIG. 13 is a flowchart for another embodiment of the sub-process for conducting analysis of the method of the present invention, wherein a plurality of investment options for the specific property is analyzed.

FIG. 14 is a flowchart for a sub-process for reporting analysis of the method of the present invention.

FIG. 15 is a flowchart for another embodiment of the sub-process for reporting analysis of the method of the present invention, wherein a webpage containing the analysis is saved and sent to the specific user.

FIG. 16 is a flowchart for a sub-process for facilitating a loan application of the method of the present invention.

FIG. 17 is a flowchart for an alternative embodiment of the sub-process for facilitating a loan application of the method of the present invention, wherein the application is sent to a mortgage lender specified by the specific user.

FIG. 18 is a flowchart for a sub-process for managing an analyzer interface of the method of the present invention.

FIG. 19 is a flowchart for an alternative embodiment of the sub-process for managing an analyzer interface of the method of the present invention, wherein a visual actuator is used to activate the mortgage analyzer interface.

FIG. 20 is a flowchart for another embodiment of the sub-process for managing an analyzer interface of the method of the present invention, wherein the visual actuator is a clickable icon.

FIG. 21 is a flowchart for another embodiment of the sub-process for managing an analyzer interface of the method of the present invention, wherein the mortgage analyzer interface is overlayed with a real estate listing website.

FIG. 22 is an exemplary illustration showing the mortgage analyzer of the present invention in use in conjunction with a real estate listing website.

FIG. 23 is an exemplary illustration showing the mortgage analyzer of the present invention in use in conjunction with the real estate listing website and analysis results for the specific real estate property.

FIG. 24 illustrates examples for sharing an investment analysis conducted by the method of the present invention.

### DETAIL DESCRIPTIONS OF THE INVENTION

All illustrations of the drawings are for the purpose of describing selected versions of the present invention and are not intended to limit the scope of the present invention.

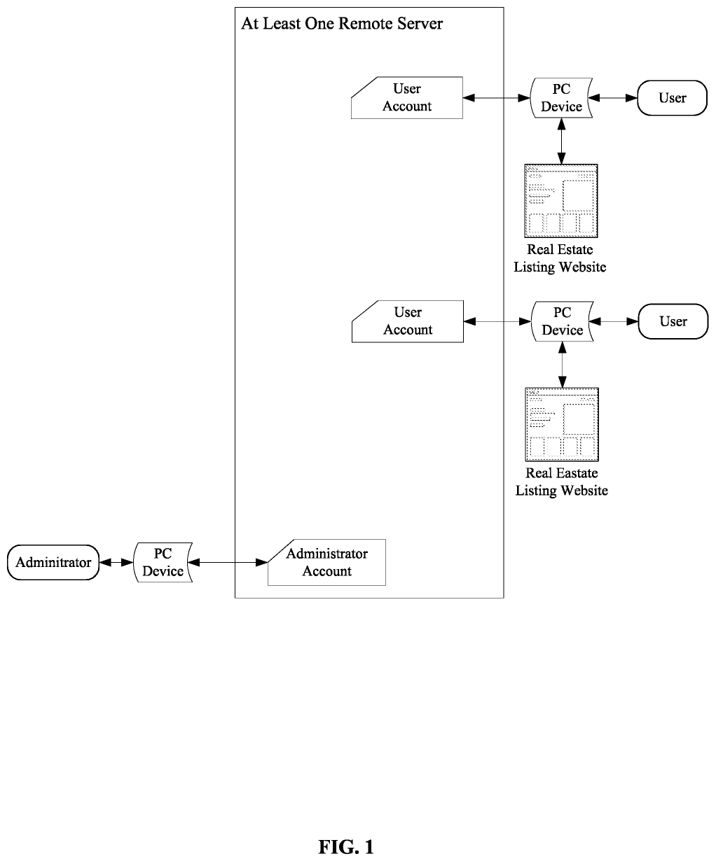

As can be seen in FIG. 1 to FIG. 24, the present invention provides a real estate mortgage and investment analysis method that is implemented through a mortgage analyzer to a user. The mortgage analyzer, also named as “StackSource Extension,” is an add-on application, or app, or extension, to an Internet© browsing client, or browser. The method of the present invention involves elements, including, but not limited to, mortgage calculations, mortgage scenario analyses, investment analysis, investment option comparisons, and mortgage rate table, etc., in the form of a browser extension. The mortgage analyzer of the method enables the user to perform calculations and analyses about prospective real estate investments viewed in an online web browser client on a webpage, save the calculations/analyses in conjunction with the webpage, and share the results with other users without leaving the browser window. The present invention goes beyond basic calculations of mortgage loan payments based on the user's input data by combining the user's input with loan rates and parameters powered by a repository of relevant financial data such as current mortgage rates. Additionally, the mortgage analyzer of the present invention scrapes information directly off property listing webpages viewed by the user, eliminating the need for manual input of information the user is already viewing as part of the mortgage and investment return calculations and analyses. The present invention may utilize PHP, JavaScript, HTML, CSS, Python, Postgre, and/or any other programming language or electronic protocol. The present invention may be understood in the preferred embodiment to be associated with an organization known as StackSource.

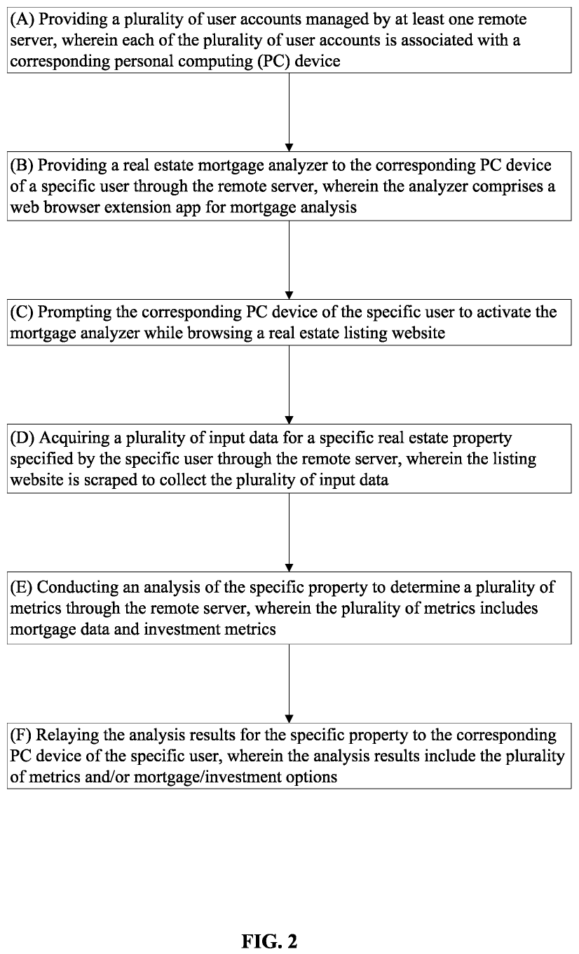

As can be seen in FIG. 1, the present invention provides an innovative mortgage analyzer app and method to facilitate mortgage calculations and investment analyses for a specific real estate property listing. To accomplish this, the method of the present invention associates each of the plurality of users with a unique user account from a plurality of user accounts that are managed by at least one remote server (Step A), as seen in FIG. 2. Each of the plurality of user accounts is associated with a corresponding personal computing (PC) device. The corresponding PC device allows the user to interact with the present invention and can be, but is not limited to, a smartphone, a smart watch, a cloud PC, a laptop, a desktop, a server, a terminal PC, or a tablet PC, etc. The users of the user accounts may include relevant parties such as, but are not limited to, individuals, consumers, home buyers, real estate investors, property owners, real estate professionals, real estate brokers, real estate agents, real estate administrators, office assistants, office managers, real estate listing providers, real estate insurers, real estate insurance providers, legal practitioners, lawyers, attorneys, managers, real estate business owners, companies, corporations, insurance companies, real estate associations, bankers, mortgage lenders, lending companies, lending institutes, lending entities, government entities, administrators, etc. Further, the at least one remote server is used to manage the mortgage analyzer app for the plurality of user accounts. The remote server can be managed through an administrator account by an administrator as seen in FIG. 1. The administrator who manages the remote server includes, but is not limited to, owner, service provider, any listed user that can access the application in compliance with the user agreement and governed by that agreement, real estate professional, real estate expert, office manager, technician, engineer, system engineer, system specialist, software engineer, information technology (IT) engineer, IT professional, IT manager, IT consultant, service desk professional, service desk manager, consultant, manager, executive officer, chief operating officer, chief technology officer, chief executive officer, president, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, cloud applications, and mobile applications compatible with a corresponding user PC device. Additionally, the software processes may store data into internal databases and communicate with external databases, which may include, but are not limited to, real estate databases, mortgage databases, loan databases, property databases, real estate market databases, rental property databases, real estate insurance databases, databases maintaining data about mortgage lending, databases maintaining regulations/laws regarding real estate mortgages, etc. The interaction with external databases over a communication network may include, but is not limited to, the Internet.

As can be seen in FIG. 2, the overall process of the method of the present invention provides the real estate mortgage analyzer to the corresponding PC device of a specific user through the remote server, wherein the analyzer comprises a web browser extension app for mortgage analysis (Step B). More specifically, the mortgage analyzer may be installed on the corresponding PC device of the specific user after registering a user account with the method of the present invention and downloaded the mortgage analyzer app.

Subsequently, the method prompts the corresponding PC device of the specific user to activate the mortgage analyzer while browsing a real estate listing website (Step C). The method of the present invention works with any internet browser, which normally resides on and is managed by the corresponding PC device of the specific user. The particular nature of the internet browser client and PC device are immaterial to the spirit of the present invention, so long as the functionality of the present invention is enabled through them. Additionally, the real estate listing website is an Internet webpage comprising information about a real estate property, including, but not limited to, a commercial property, a residential property, etc. In many cases, the listing webpage is specifically intended to display information about the real estate property for sale through an entity such as a property listing portal, though it should be noted that this may not always be the case, and other types of webpages besides property listing portals may conceivably play the same functional role in the present invention. Normally, the specific user accesses a real estate listing website through the internet browser client with the corresponding PC device. For example, a user may use the internet browser client to navigate to a property listing portal, perform a search on the property listing portal corresponding to various parameters relevant to the specific user, including, but not limited to, a desired location, property type, and price range, and select a specific property listing in the list of results returned by the property listing portal. Once the third-party listing is fetched by and displayed on the internet browsing client, the user may activate the browser extension of the present invention; alternatively, in some embodiments, the mortgage analyzer may automatically initialize itself upon detection of a property listing being viewed on the corresponding PC device of the specific user.

Further, the method acquires a plurality of input data for a specific real estate property specified by the specific user through the remote server, wherein the listing website is scraped to collect the plurality of input data (Step D). More specifically, the method acquires a plurality of real estate listing data from the listing website through a process commonly known as “scraping”, and it is contemplated herein that the scraping process may be implemented in many variations which can ultimately produce the same desired effect; that is, to extract relevant information from the real estate listing webpage in order to utilize the relevant information in conjunction with method of the present invention. Additionally, the plurality of input data may include, but not limited to, a plurality of real estate lending data, real estate market data/information, and/or a plurality of input data of the specific user through an interaction interface of the present invention.

Subsequently, the method conducts an analysis of the specific property to determine a plurality of metrics through the remote server, wherein the plurality of metrics includes mortgage data and investment metrics (Step E). In any case, the mortgage and investment analysis is generated with the remote server according to an analysis type, the user input, and the plurality of lending data, and the analysis is displayed on the analysis interface. The analysis produces various results, including, but not limited to, mortgage interest rates or a range thereof, a maximum loan amount for the property, interest and principal payment amounts, a net cash flow value, a capitalization (Cap) rate, a maximum loan-to-value (LTV) ratio, and a cash-on-cash return (CCR) value, etc. Such calculated metrics based on the initial assumptions/input data used in the analysis empower the user to make an informed decision as to whether a certain property would be a good investment and may further provide insight in regard to conditions that may need to change or actions that may need to be taken in order to maximize the value of the prospective investment.

Further, the method relays the analysis results for the specific property to the corresponding PC device of the specific user, wherein the analysis results include the plurality of metrics and/or mortgage/investment options (Step F). The method saves all input data acquired, calculations, analyses, etc. Additionally, the method allows the specific user to send/share the analysis results via digital documentation and/or webpages for the specific property.

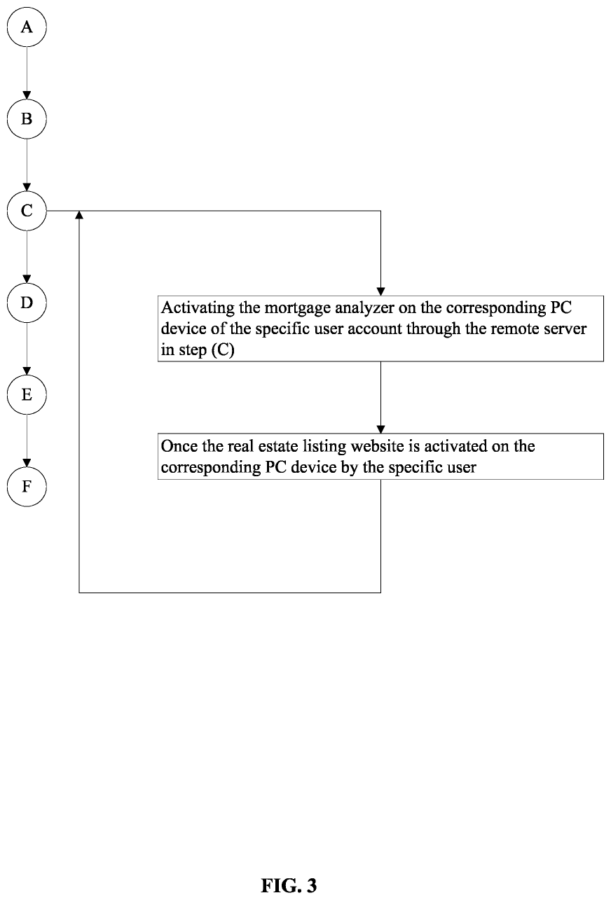

As can be seen in FIG. 3, the method of the present invention provides a sub-process for activating the mortgage analyzer app. More specifically, the method activates the mortgage analyzer on the corresponding PC device of the specific user account through the remote server in Step C once the real estate listing website is activated on the corresponding PC device by the specific user. This sub-process provides an automatic activation when the specific user opens a real estate listing website.

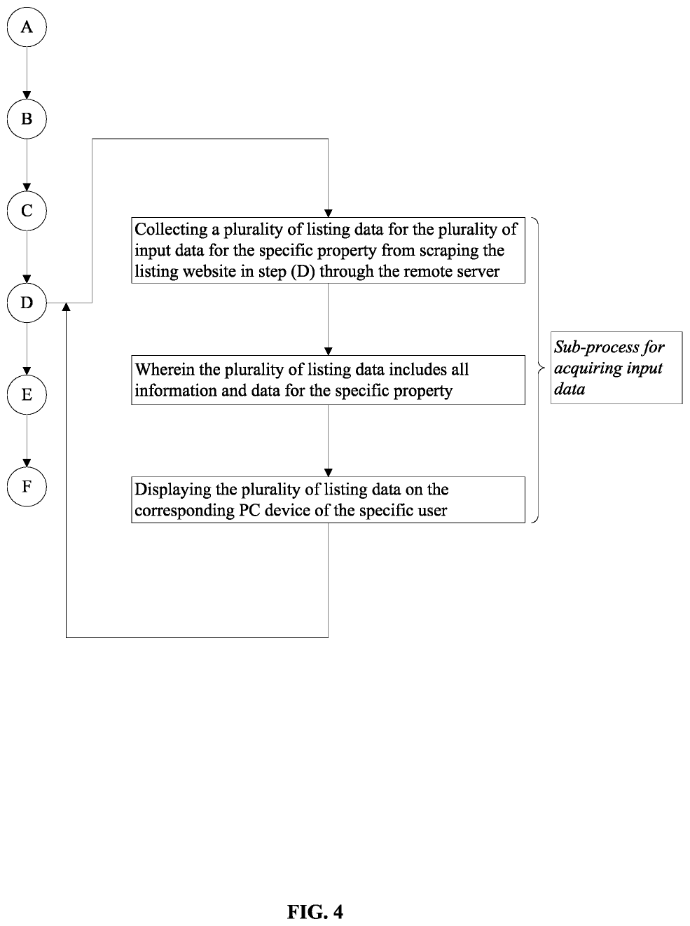

As can be seen in FIG. 4, the method provides a sub-process for acquiring input data for the mortgage analysis. More specifically, the method collects a plurality of listing data for the plurality of input data for the specific property from scraping the listing website in Step D through the remote server, wherein the plurality of listing data includes all information and data for the specific property. Subsequently, the method displays the plurality of listing data on the corresponding PC device of the specific user. In this sub-process, the real estate listing is scraped dynamically by the method as soon as the webpage for the listing is fetched by the internet browser client on the corresponding PC device of the specific user. In some embodiments, the method of the present invention implements an automated, regular pre-scraping of various entities such as real estate property listing portals so that the relevant data is available to the system of the present invention in advance. The plurality of listing data may include, but is not limited to, asking price of the specific property, net operating income, market cap rate, etc.

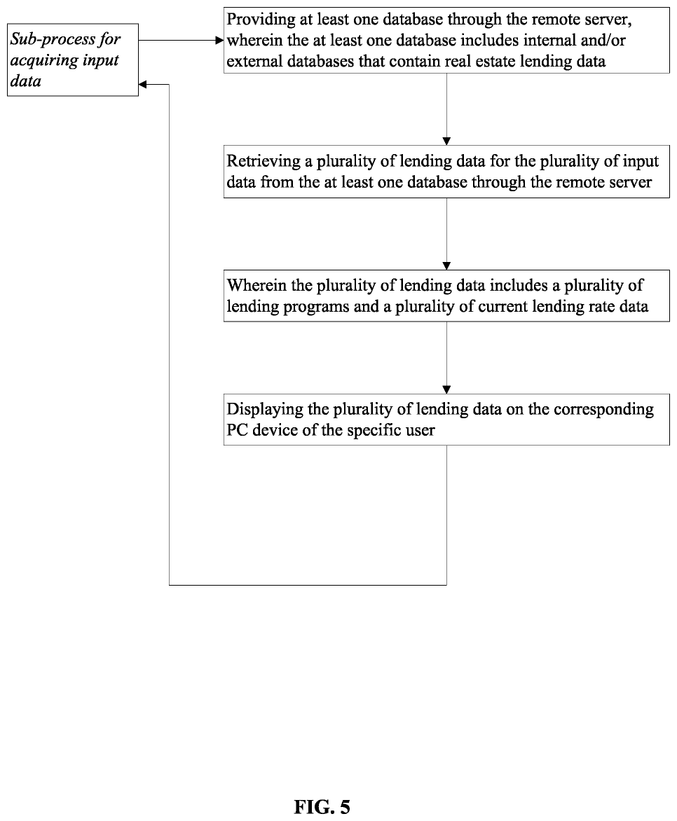

As can be seen in FIG. 5, in an alternative embodiment of the present invention, the sub-process for acquiring input data for the mortgage analysis acquires input data from databases. More specifically, the method provides at least one database through the remote server, wherein the at least one database includes internal and/or external databases that contain real estate lending data. The method retrieves a plurality of lending data for the plurality of input data from the at least one database through the remote server, wherein the plurality of lending data includes a plurality of lending programs and a plurality of current lending rate data. Subsequently, the method displays the plurality of lending data on the corresponding PC device of the specific user. The plurality of lending data comprises a list of mortgage lending programs and a plurality of current lending rate data. The plurality of lending programs is retrieved according to current market conditions, and may potentially be tailored to the type of real estate investment being viewed within the internet browser client on the corresponding PC device of the specific user. The plurality of current lending rate data may be retrieved originally from various sources, but in general corresponds to up-to-date market conditions in terms of the interest rates and other relevant attributes of the most recent mortgages being initiated. Sources of the current lending rate data may include, but are not limited to, government sources such as the U.S. Treasury or Federal Reserve, as well as private repositories of lending data, including data collected by an entity such as a private company that provides such lending programs themselves. Thus, through the present invention, the specific user is empowered to make informed decisions through a streamlined process of information collection and presentation, which the specific user may have otherwise had to perform on their own or request from a lending institution or other relevant entity.

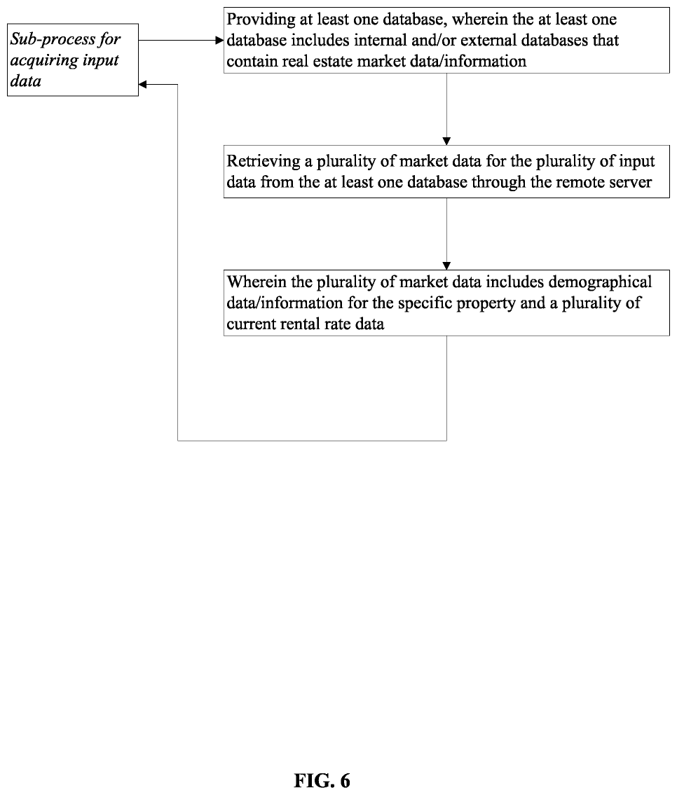

As can be seen in FIG. 6, in another embodiment of the present invention, the sub-process for acquiring input data for the mortgage analysis acquires real estate market data/information for the input data from databases. More specifically, the method provides at least one database, wherein the at least one database includes internal and/or external databases that contain real estate market data/information. The method retrieves a plurality of market data for the plurality of input data from the at least one database through the remote server, wherein the plurality of market data includes demographic data/information for the specific property and a plurality of current rental rate data. The method retrieves various relevant market information to incorporate into the mortgage and investment analysis. Such market information may include, but is not limited to, comparable rental rates, comparable Cap rates, population and demographics for the surrounding area of the specific property, and automated valuations thereof and/or other similar or nearby property listings. Retrieval of the market information/data may be based on the location and nature of the real estate listing and/or other relevant factors not discussed herein.

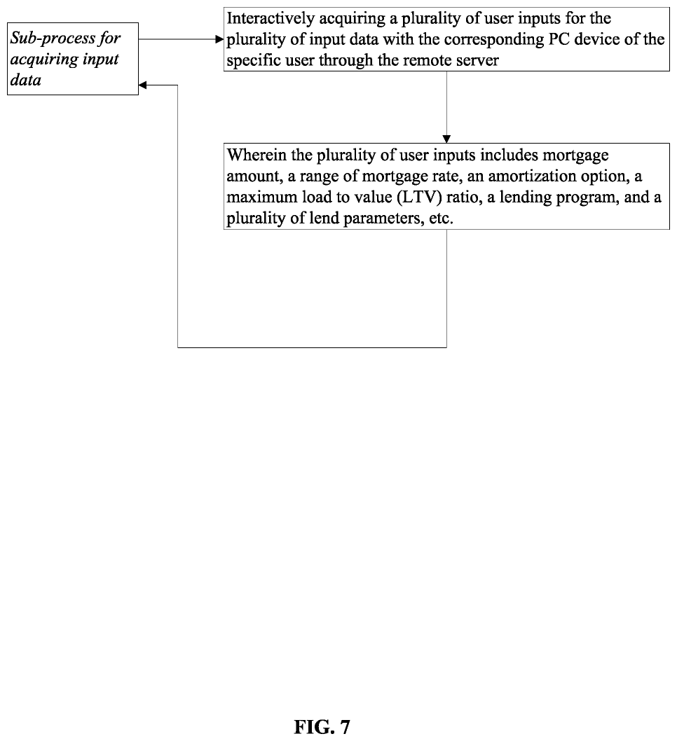

As can be seen in FIG. 7, in another embodiment of the present invention, the sub-process for acquiring input data for the mortgage analysis acquires user input data through interactions. More specifically, the method interactively acquires a plurality of user inputs for the plurality of input data with the corresponding PC device of the specific user through the remote server, wherein the plurality of user inputs includes mortgage amount, a range of mortgage rate, an amortization option, a maximum load to value (LTV) ratio, a lending program, and a plurality of lending parameters, etc. The plurality of user inputs is received through the analysis interface, wherein the user input comprises a mortgage lending program selection, a plurality of lending parameter inputs, etc. Once a lending program is selected, various lending parameters are then applied to the analysis. Such parameters may include, but are not limited to, commercial mortgage rate range, maximum loan to value (LTV) ratio, amortization options, and other relevant financial parameters of a real estate mortgage loan as appropriate. In some cases, the user is presented with an additional interface that allows them to select specific values or ranges of values for one or more of the lending parameters. For example, the user may be presented with a slider bar through which the user may select a specific interest rate or maximum LTV as one or more of the plurality of lending parameters, or the user may alternatively type a value in an associated text box. In another example, the user may be presented with a drop-down menu from which a duration of an amortization period of a prospective mortgage for the specific property can be selected. The mortgage rate data is retrieved through the remote server from the database in one of two ways. First, an analysis type may be determined through the remote server from the lending program selection and the plurality of lending parameters acquired. Second, the mortgage rate data is retrieved as a range of rates collected as part of the aforementioned mortgage parameters. In some instances, the mortgage rate data is retrieved as a specific “Instant Rate Quote.” In other embodiments, the Instant Rate Quote will be generated from a computation executed by the remote server and transmitted back to the mortgage analyzer app of the present invention. The Instant Rate Quote is dependent on additional input data from the user that are specific to the loan program being selected. Rather than a range of interest rates being returned, a specific interest rate is returned and set within the investment analysis.

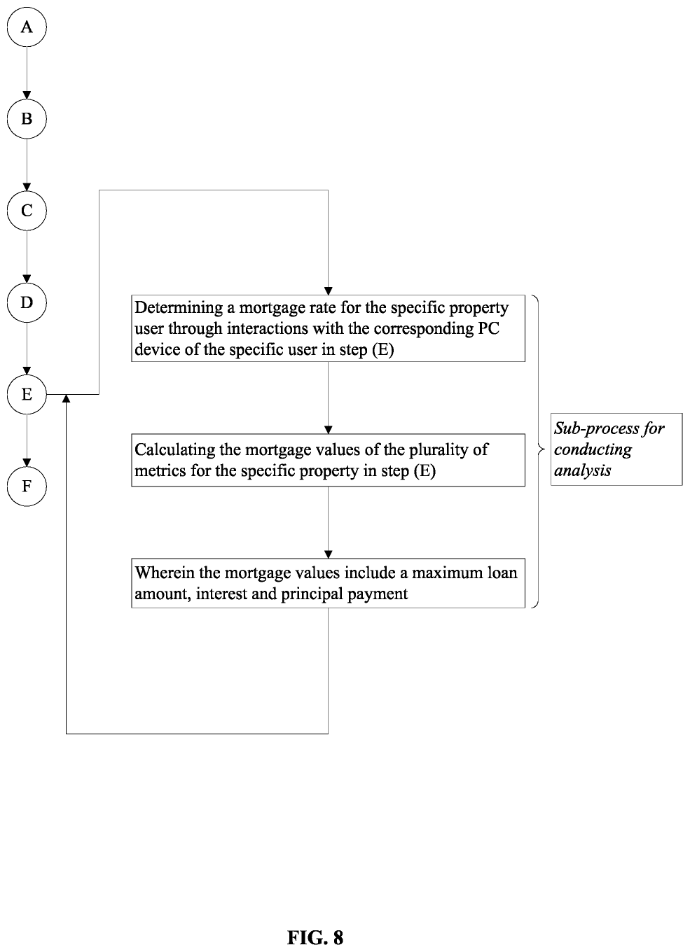

As can be seen in FIG. 8, the method provides a sub-process for conducting mortgage analyses. More specifically, the method determines a mortgage rate for the specific property user through interactions with the corresponding PC device of the specific user in Step E. Subsequently, the method calculates the mortgage values of the plurality of metrics for the specific property in Step E, wherein the mortgage values include a maximum loan amount, interest and principal payment.

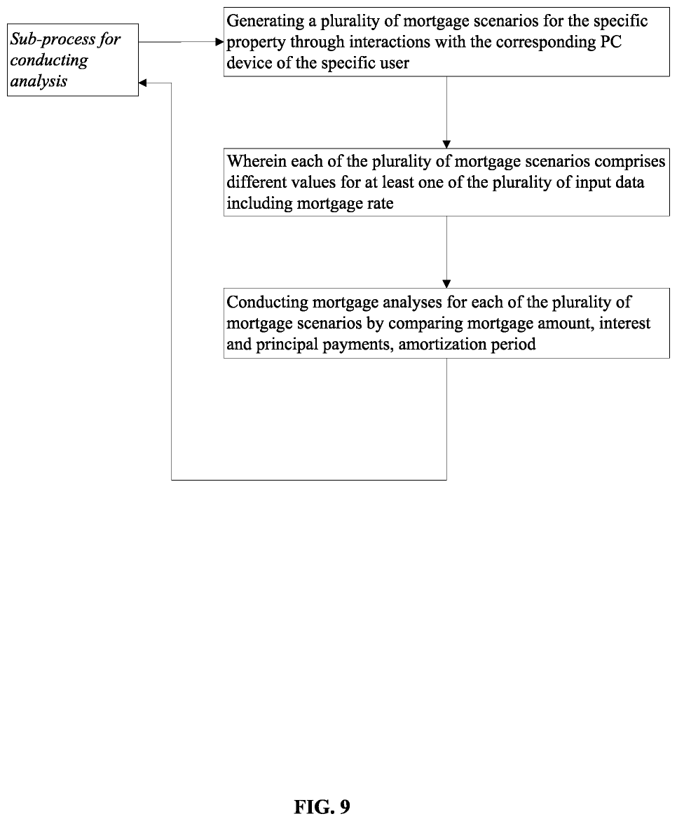

As can be seen in FIG. 9, in an alternative embodiment, the method provides a sub-process for conducting mortgage analyses. More specifically, the method generates a plurality of mortgage scenarios for the specific property through interactions with the corresponding PC device of the specific user, wherein each of the plurality of mortgage scenarios comprises different values for at least one of the plurality of input data including mortgage rate. Subsequently, the method conducts mortgage analyses for each of the plurality of mortgage scenarios by comparing mortgage amount, interest and principal payments, and amortization period.

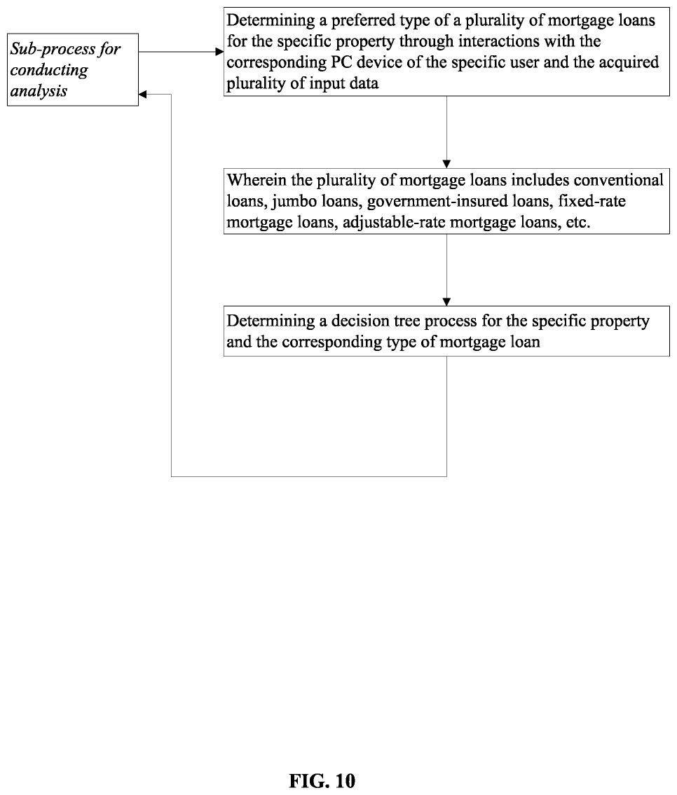

As can be seen in FIG. 10, in another embodiment, the method provides a sub-process for conducting mortgage analyses. More specifically, the method determines a preferred type of a plurality of mortgage loans for the specific property through interactions with the corresponding PC device of the specific user and the acquired plurality of input data, wherein the plurality of mortgage loans includes Freddie Mac Optigo, Fannie Mae, HUD 223(f), CMBS, Regional Banks, Credit Unions, Life Insurance Companies, Debt Funds, National Banks, etc. Subsequently, the method determines a decision tree process for the specific property and the corresponding type of mortgage loan.

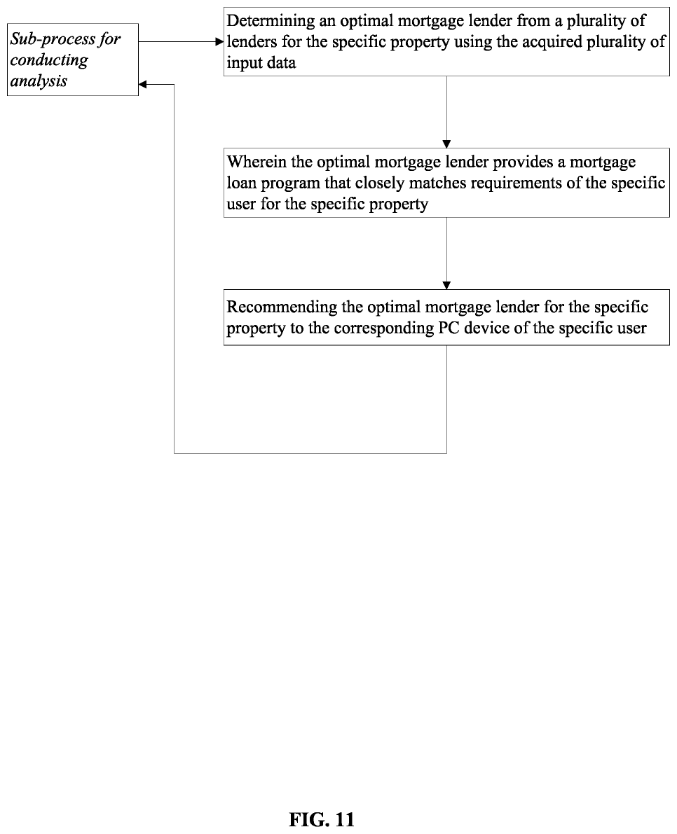

As can be seen in FIG. 11, in another embodiment, the method provides a sub-process for conducting mortgage analyses. More specifically, the method determines an optimal mortgage lender from a plurality of lenders for the specific property using the acquired plurality of input data, wherein the optimal mortgage lender provides a mortgage loan program that closely matches requirements of the specific user for the specific property. Subsequently, the method recommends the optimal mortgage lender for the specific property to the corresponding PC device of the specific user.

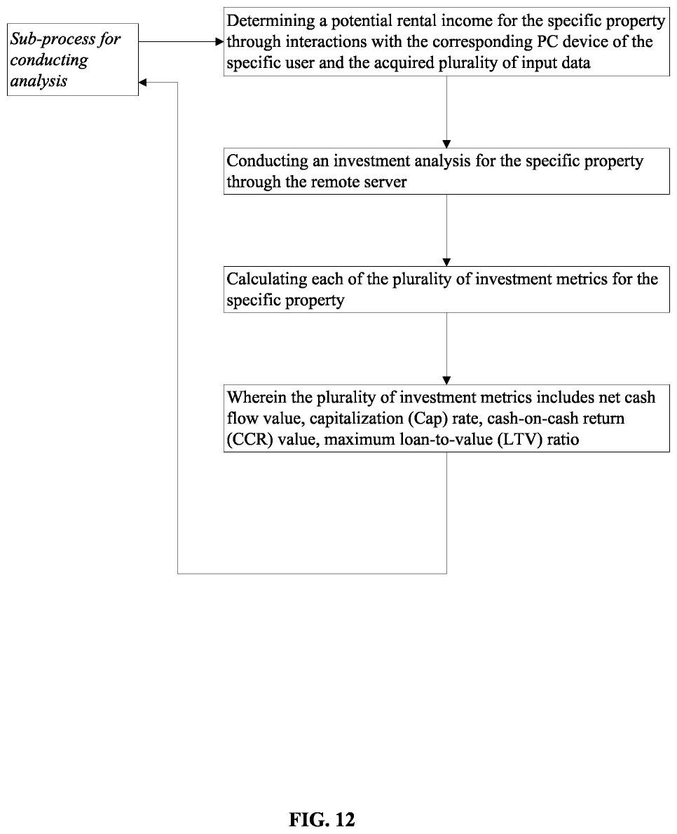

As can be seen in FIG. 12, in another embodiment, the method provides a sub-process for conducting mortgage analyses. More specifically, the method determines a potential rental income for the specific property through interactions with the corresponding PC device of the specific user and the acquired plurality of input data. The method conducts an investment analysis for the specific property through the remote server. And the method calculates each of the plurality of investment metrics for the specific property, wherein the plurality of investment metrics includes net cash flow value, capitalization (Cap) rate, cash-on-cash return (CCR) value, maximum loan-to-value (LTV) ratio.

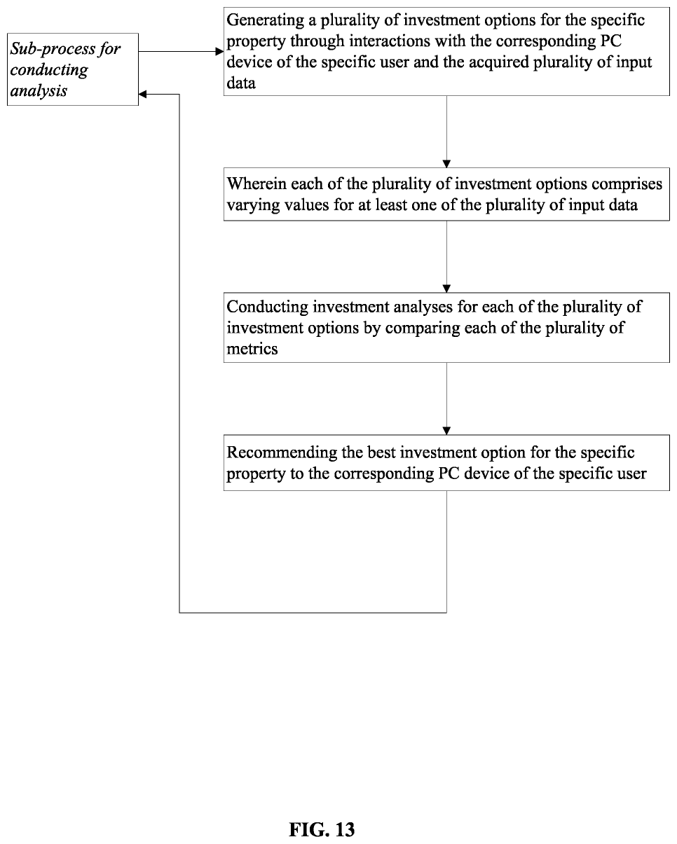

As can be seen in FIG. 13, in yet another embodiment, the method provides a sub-process for conducting mortgage analyses. More specifically, the method generates a plurality of investment options for the specific property through interactions with the corresponding PC device of the specific user and the acquired plurality of input data, wherein each of the plurality of investment options comprises varying values for at least one of the plurality of input data. The method conducts investment analyses for each of the plurality of investment options by comparing each of the plurality of metrics, and recommends the best investment option for the specific property to the corresponding PC device of the specific user.

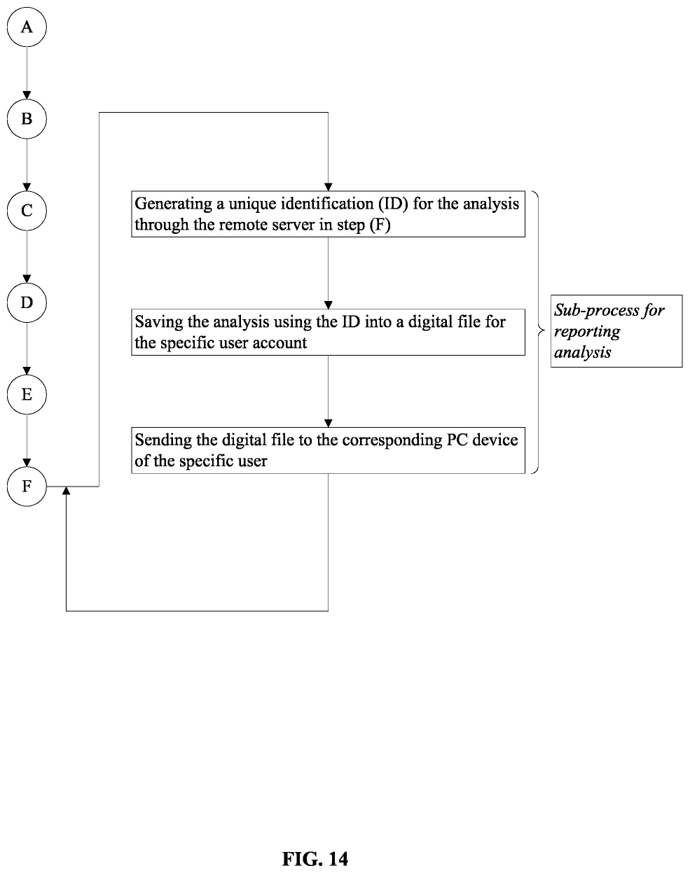

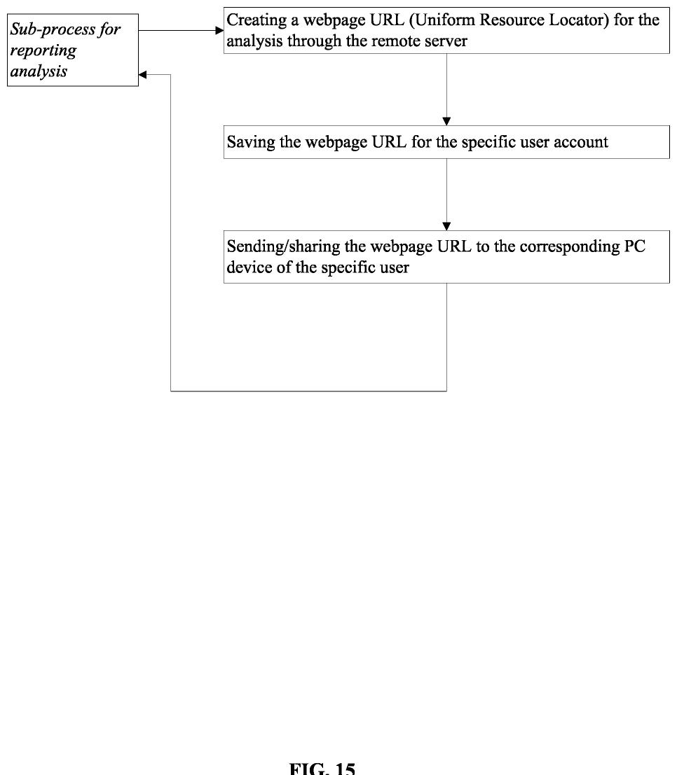

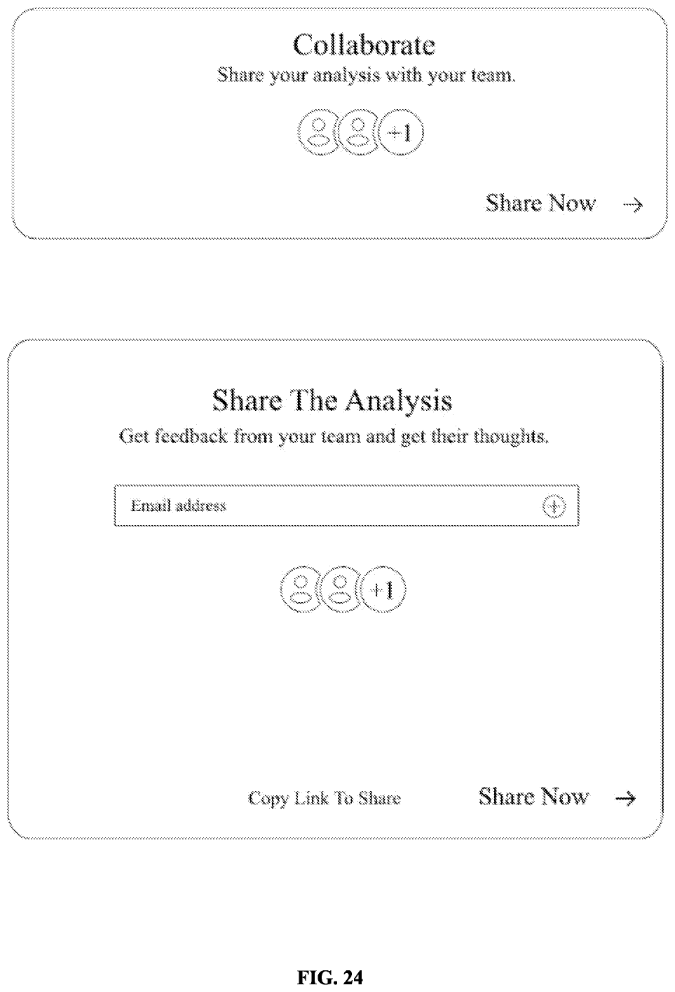

As can be seen in FIG. 14, the method provides a sub-process for reporting the mortgage analysis. More specifically, the method generates a unique identification (ID) for the analysis through the remote server in Step F. The method then saves the analysis using the ID into a digital file for the specific user account, and sends the digital file to the corresponding PC device of the specific user. As can be seen in FIG. 15, in an alternative embodiment, the method provides a sub-process for reporting the mortgage analysis. More specifically, the method creates a webpage URL (Uniform Resource Locator) for the analysis through the remote server. Then, the method saves the webpage URL for the specific user account, and sends/shares the webpage URL to the corresponding PC device of the specific user. The identifier string unique to the analysis is generated and passed to the Internet URL that can be shared with others. As can be seen in FIG. 24, in other embodiments, the specific means of sharing the investment analysis may vary as desired. For example, in some embodiments, the investment analysis may be compiled into a digital document or image file that may be shared through any applicable means, such as via email or any file sharing service. Additionally, the investment analysis may be stored in association with the real estate listing to a list of saved analyses. This may be accomplished utilizing the aforementioned means of sharing the investment analysis, or other relevant means may be implemented as desired and applicable.

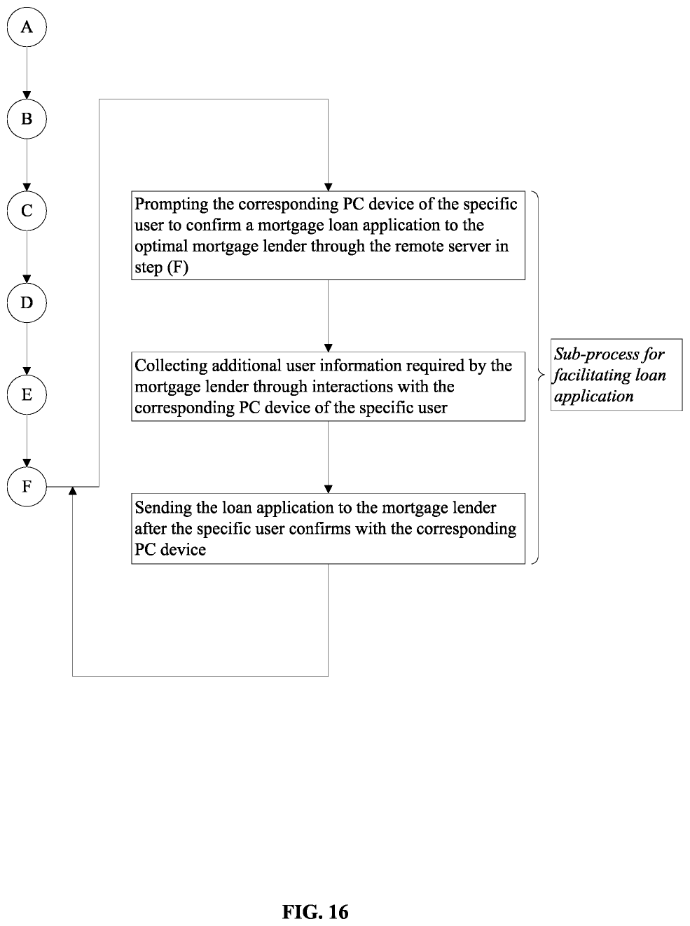

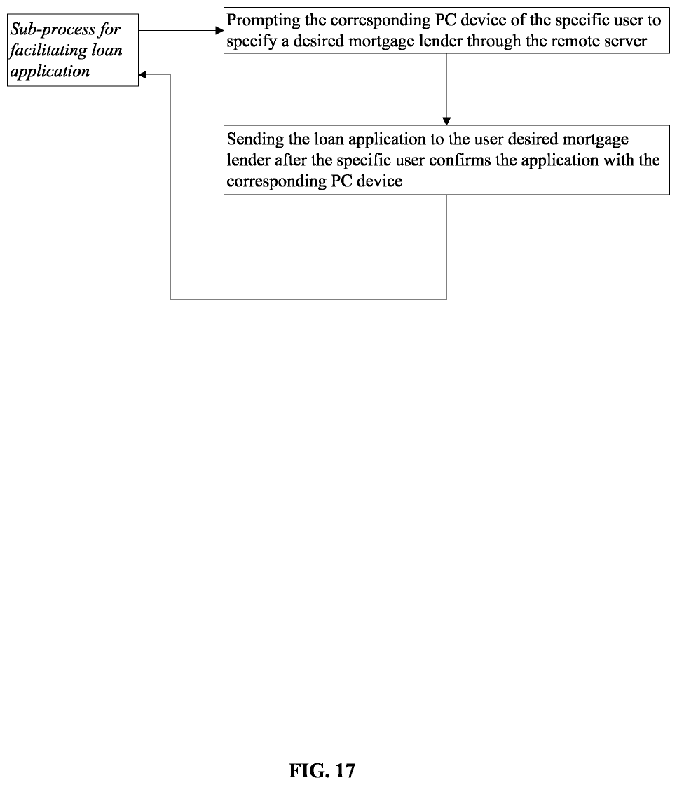

As can be seen in FIG. 16, the method provides a sub-process for facilitating a mortgage loan application. More specifically, the method prompts the corresponding PC device of the specific user to confirm a mortgage loan application to the optimal mortgage lender through the remote server in Step F. The method then collects additional user information required by the mortgage lender through interactions with the corresponding PC device of the specific user, and sends the loan application to the mortgage lender after the specific user confirms with the corresponding PC device. As can be seen in FIG. 17, in an alternative embodiment, the method provides a sub-process for facilitating the mortgage loan application. More specifically, the method prompts the corresponding PC device of the specific user to specify a desired mortgage lender through the remote server, and sends the loan application to the user desired mortgage lender after the specific user confirms the application with the corresponding PC device. After the investment analysis is completed, the method enables the user to initiate the loan request to lenders that are algorithmically matched to be a fit based on the output of the investment analysis. One or more lending entities may participate in the ecosystem of the present invention and establish, for example, a range of various lending parameters such as an interest rate or range or a loan amount range that the lending entities are willing to offer to users of the present invention based on certain criteria. For example, a lending entity may wish to provide loans for apartment buildings in a certain locality up to a specified maximum loan amount. If a user initiates an investment analysis for an apartment building within the certain locality, and the investment analysis determines a maximum loan amount below the specified maximum loan amount, the present invention may further present the user with the option to initiate a loan request to the lending entity through the mortgage analyzer.

Further, in some embodiments, the present invention may provide an option to the user to initiate a full underwriting model on a third-party underwriting platform or spreadsheet based on the information captured in the investment analysis.

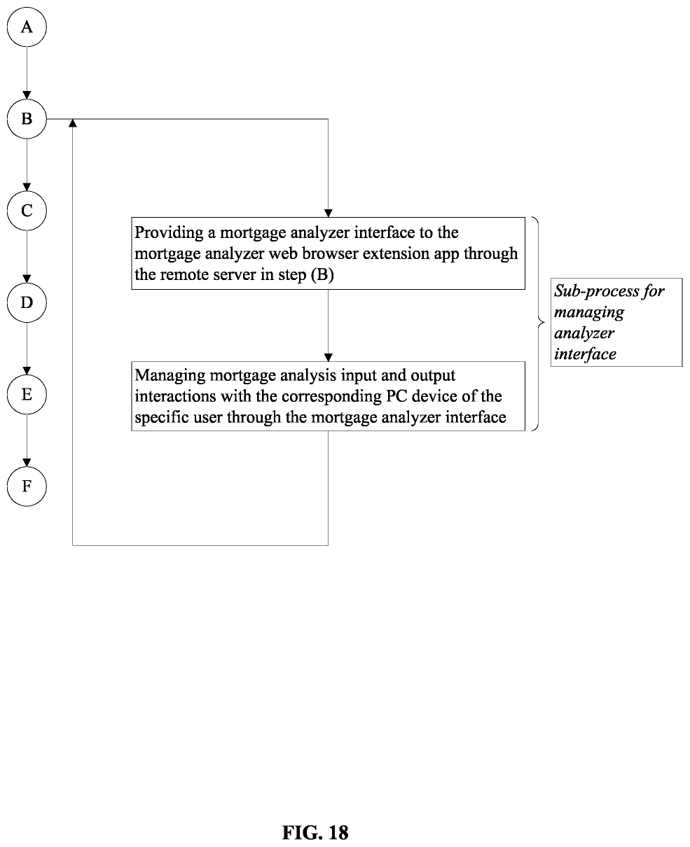

As can be seen in FIG. 18, the method provides a sub-process for managing the mortgage analyzer interface. More specifically, the method provides a mortgage analyzer interface to the mortgage analyzer web browser extension app through the remote server in Step B. The method then manages the mortgage analysis input and output interactions with the corresponding PC device of the specific user through the mortgage analyzer interface.

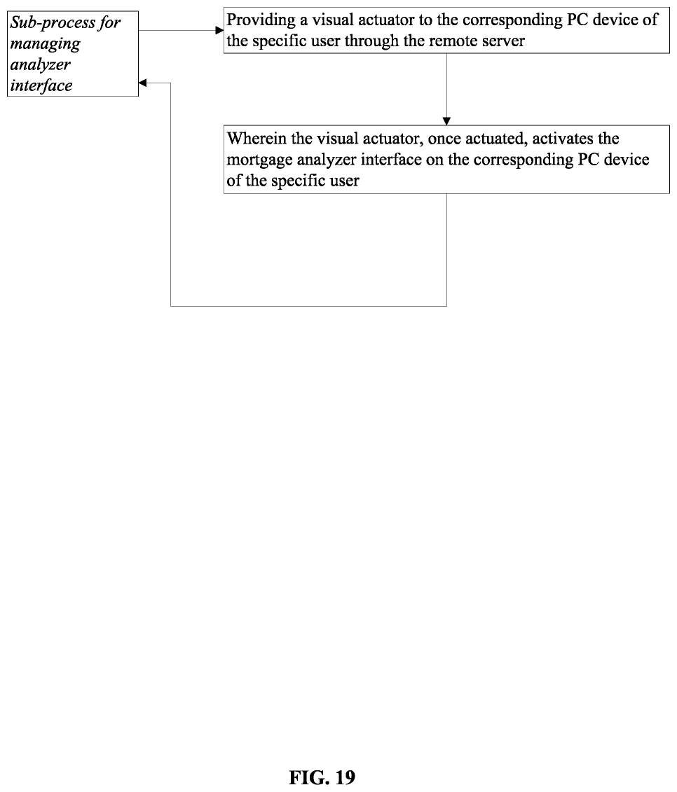

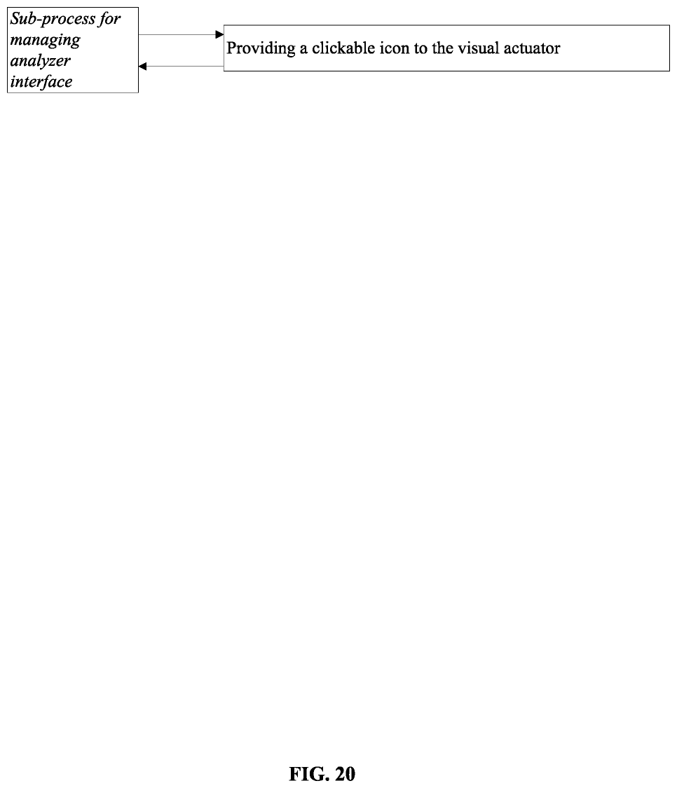

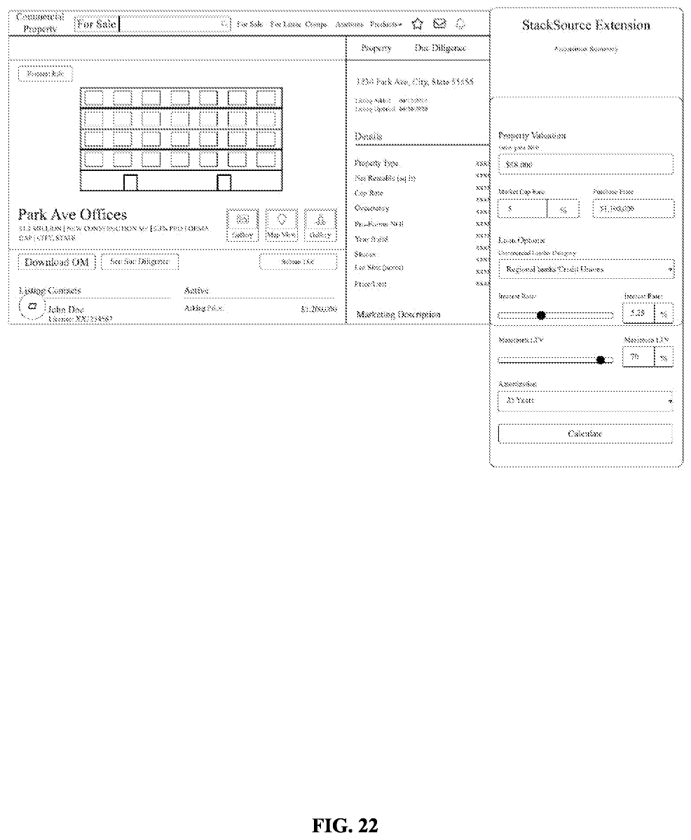

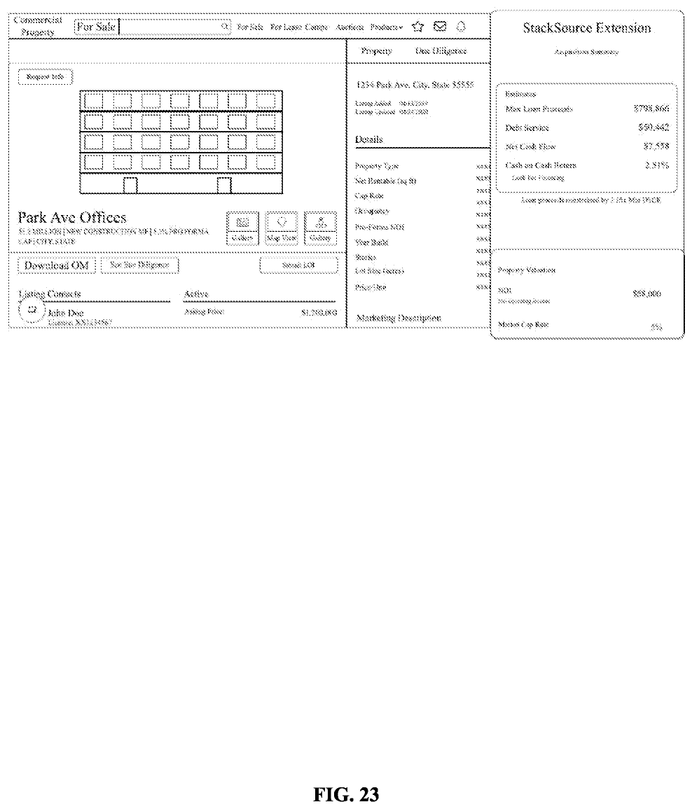

As can be seen in FIG. 19, in an alternative embodiment, the method provides a sub-process for managing the mortgage analyzer interface. More specifically, the method provides a visual actuator to the corresponding PC device of the specific user through the remote server, wherein the visual actuator, once actuated, activates the mortgage analyzer interface on the corresponding PC device of the specific user. As can be seen in FIG. 22, an exemplary illustration of the analyzer interface initiated on a real estate listing webpage for a property includes input and output data for a mortgage analysis using the present invention. As can be seen in FIG. 20, in another embodiment, the method provides a sub-process for managing the mortgage analyzer interface. More specifically, the method provides a clickable icon to the visual actuator. The specific means of initiating the analyzer interface may vary in different embodiments; however, in the preferred embodiment, the method of the present invention adds an icon or other visual element to the webpage of the listing website being viewed, as can be seen in FIG. 22 and FIG. 23. The user may click on or otherwise interact with the icon in order to initialize the analyzer interface. Preferably, the analyzer interface is a new window, frame, or other display element that is visually and functionally separate from the listing website.

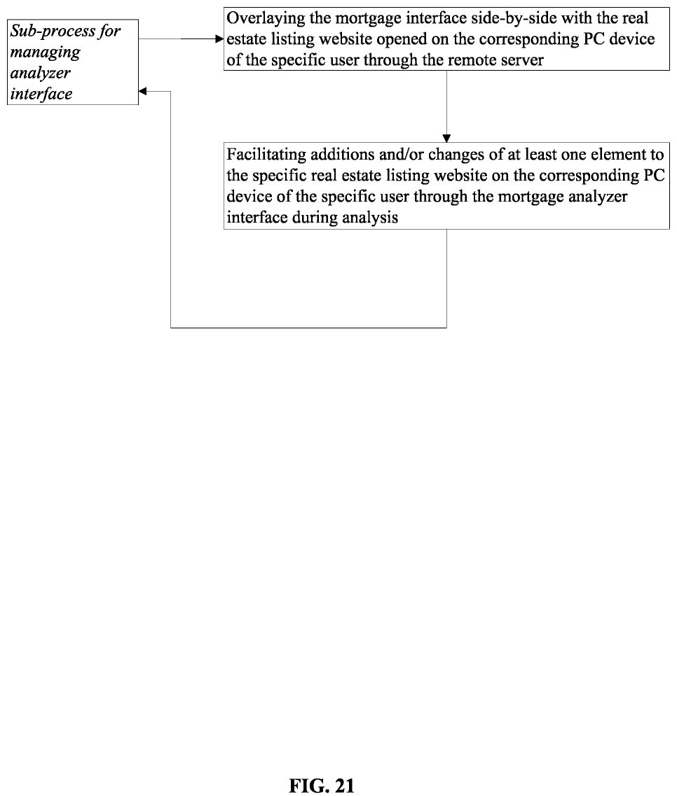

As can be seen in FIG. 21, in yet another embodiment, the method provides a sub-process for managing the mortgage analyzer interface. More specifically, the method overlays the mortgage interface side-by-side with the real estate listing website opened on the corresponding PC device of the specific user through the remote server. Further, the method facilitates additions and/or changes of at least one element to the specific real estate listing website on the corresponding PC device of the specific user through the mortgage analyzer interface during analysis. The analyzer interface is an overlay positioned side-by-side with the content of the listing website being viewed. In other embodiments, the analyzer interface may insert additional elements or modify existing elements on the third-party listing webpage within the internet browser client to the same or similar effect.

Although the invention has been explained in relation to its preferred embodiment, it is to be understood that many other possible modifications and variations can be made without departing from the spirit and scope of the invention as hereinafter claimed.

What is claimed is:

1. A method for providing mortgage and investment analyses of a real estate property comprising the steps of:
(A) providing a plurality of user accounts managed by at least one remote server, wherein each of the plurality of user accounts is associated with a corresponding personal computing (PC) device;
(B) providing a real estate mortgage analyzer to the corresponding PC device of a specific user through the remote server, wherein the analyzer comprises a web browser extension app for mortgage analysis;
(C) prompting the corresponding PC device of the specific user to activate the mortgage analyzer while browsing a real estate listing web site;
(D) acquiring a plurality of input data for a specific real estate property specified by the specific user through the remote server, wherein the listing website is scraped to collect the plurality of input data;
(E) conducting an analysis of the specific property to determine a plurality of metrics through the remote server, wherein the plurality of metrics includes mortgage data and investment metrics; and
(F) relaying the analysis results for the specific property to the corresponding PC device of the specific user, wherein the analysis results include the plurality of metrics and/or mortgage/investment options.

2. The method for providing mortgage and investment analyses of a real estate property as claimed in claim 1 comprising the steps of:
activating the mortgage analyzer on the corresponding PC device of the specific user account through the remote server in step (C); and
once the real estate listing website is activated on the corresponding PC device by the specific user.

3. The method for providing mortgage and investment analyses of a real estate property as claimed in claim 1 comprising the steps of:
collecting a plurality of listing data for the plurality of input data for the specific property from scraping the listing website in step (D) through the remote server;
wherein the plurality of listing data includes all information and data for the specific property; and
displaying the plurality of listing data on the corresponding PC device of the specific user.

4. The method for providing mortgage and investment analyses of a real estate property as claimed in claim 1 comprising the steps of:
providing at least one database through the remote server, wherein the at least one database includes internal and/or external databases that contain real estate lending data;
retrieving a plurality of lending data for the plurality of input data from the at least one database through the remote server;
wherein the plurality of lending data includes a plurality of lending programs and a plurality of current lending rate data; and
displaying the plurality of lending data on the corresponding PC device of the specific user.

5. The method for providing mortgage and investment analyses of a real estate property as claimed in claim 1 comprising the steps of:
providing at least one database, wherein the at least one database includes internal and/or external databases that contain real estate market data/information;
retrieving a plurality of market data for the plurality of input data from the at least one database through the remote server; and
wherein the plurality of market data includes demographic data/information for the specific property and a plurality of current rental rate data.

6. The method for providing mortgage and investment analyses of a real estate property as claimed in claim 1 comprising the steps of:
interactively acquiring a plurality of user inputs for the plurality of input data with the corresponding PC device of the specific user through the remote server; and
wherein the plurality of user inputs includes mortgage amount, a range of mortgage rate, an amortization option, a maximum loan-to-value (LTV) ratio, a lending program, and a plurality of lend parameters, etc.

7. The method for providing mortgage and investment analyses of a real estate property as claimed in claim 1 comprising the steps of:
determining a mortgage rate for the specific property user through interactions with the corresponding PC device of the specific user in step (E);
calculating the mortgage values of the plurality of metrics for the specific property in step (E); and
wherein the mortgage values include a maximum loan amount, interest and principal payment.

8. The method for providing mortgage and investment analyses of a real estate property as claimed in claim 1 comprising the steps of:
generating a plurality of mortgage scenarios for the specific property through interactions with the corresponding PC device of the specific user;
wherein each of the plurality of mortgage scenarios comprises different values for at least one of the plurality of input data including mortgage rate; and
conducting mortgage analyses for each of the plurality of mortgage scenarios by comparing mortgage amount, interest and principal payments, amortization period.

9. The method for providing mortgage and investment analyses of a real estate property as claimed in claim 1 comprising the steps of:
determining a preferred type of a plurality of mortgage loans for the specific property through interactions with the corresponding PC device of the specific user and the acquired plurality of input data;
wherein the plurality of mortgage loans includes Freddie Mac Optigo, Fannie Mae, HUD 223(f), CMBS, Regional Banks, Credit Unions, Life Insurance Companies, Debt Funds, National Banks, etc.; and
determining a decision tree process for the specific property and the corresponding type of mortgage loan.

10. The method for providing mortgage and investment analyses of a real estate property as claimed in claim 1 comprising the steps of:
determining an optimal mortgage lender from a plurality of lenders for the specific property using the acquired plurality of input data;
wherein the optimal mortgage lender provides a mortgage loan program that closely matches requirements of the specific user for the specific property; and
recommending the optimal mortgage lender for the specific property to the corresponding PC device of the specific user.

11. The method for providing mortgage and investment analyses of a real estate property as claimed in claim 1 comprising the steps of:
determining a potential rental income for the specific property through interactions with the corresponding PC device of the specific user and the acquired plurality of input data;
conducting an investment analysis for the specific property through the remote server;
calculating each of the plurality of investment metrics for the specific property; and
wherein the plurality of investment metrics includes net cash flow value, capitalization (Cap) rate, cash-on-cash return (CCR) value, maximum LTV ratio, etc.

12. The method for providing mortgage and investment analyses of a real estate property as claimed in claim 1 comprising the steps of:
generating a plurality of investment options for the specific property through interactions with the corresponding PC device of the specific user and the acquired plurality of input data;
wherein each of the plurality of investment options comprises varying values for at least one of the plurality of input data;
conducting investment analyses for each of the plurality of investment options by comparing each of the plurality of metrics; and
recommending the best investment option for the specific property to the corresponding PC device of the specific user.

13. The method for providing mortgage and investment analyses of a real estate property as claimed in claim 1 comprising the steps of:
generating a unique identification (ID) for the analysis through the remote server in step (F);
saving the analysis using the ID into a digital file for the specific user account; and
sending the digital file to the corresponding PC device of the specific user.

14. The method for providing mortgage and investment analyses of a real estate property as claimed in claim 1 comprising the steps of:
creating a webpage URL (Uniform Resource Locator) for the analysis through the remote server;
saving the webpage URL for the specific user account; and
sending/sharing the webpage URL to the corresponding PC device of the specific user.

15. The method for providing mortgage and investment analyses of a real estate property as claimed in claim 1 comprising the steps of:
prompting the corresponding PC device of the specific user to confirm a mortgage loan application to the optimal mortgage lender through the remote server in step (F);
collecting additional user information required by the mortgage lender through interactions with the corresponding PC device of the specific user; and
sending the loan application to the mortgage lender after the specific user confirms with the corresponding PC device.

16. The method for providing mortgage and investment analyses of a real estate property as claimed in claim 15 comprising the steps of:
prompting the corresponding PC device of the specific user to specify a desired mortgage lender through the remote server; and
sending the loan application to the user desired mortgage lender after the specific user confirms the application with the corresponding PC device.

17. The method for providing mortgage and investment analyses of a real estate property as claimed in claim 1 comprising the steps of:
providing a mortgage analyzer interface to the mortgage analyzer web browser extension app through the remote server in step (B); and
managing mortgage analysis input and output interactions with the corresponding PC device of the specific user through the mortgage analyzer interface.

18. The method for providing mortgage and investment analyses of a real estate property as claimed in claim 17 comprising the steps of:
providing a visual actuator to the corresponding PC device of the specific user through the remote server; and
wherein the visual actuator, once actuated, activates the mortgage analyzer interface on the corresponding PC device of the specific user.

19. The method for providing mortgage and investment analyses of a real estate property as claimed in claim 17 comprising the steps of:
providing a clickable icon to the visual actuator.

20. The method for providing mortgage and investment analyses of a real estate property as claimed in claim 17 comprising the steps of:
overlaying the mortgage interface side-by-side with the real estate listing website opened on the corresponding PC device of the specific user through the remote server; and
facilitating additions and/or changes of at least one element to the specific real estate listing website on the corresponding PC device of the specific user through the mortgage analyzer interface during analysis.
